(19) United States
(12) Patent Application Publication
(10) Pub. No.: US 2010/0275146 A1
(43) Pub. Date: Oct. 28, 2010

(54) System and method for managing devices in an information handling system

(75) Inventors: Hsien-Pao Sun, Taipei City (TW); Yu-Fu Kuo, Taipei County (TW); Che-Kuan Chiu, Taipei County (TW); Yuan-Hao Chang, Taipei County (TW)

Correspondence Address: LARSON NEWMAN & ABEL, LLP, 5914 WEST COURTYARD DRIVE, SUITE 200, AUSTIN, TX, 78730, US

(73) Assignee: Dell Products, LP, Round Rock, TX (US)

(21) Appl. No.: 12/429,365

(22) Filed: Apr. 24, 2009

(51) Int. Cl. G06F 3/048

(52) U.S. Cl. 715/771

(57) ABSTRACT

An information handling system stores code, layout information, and location information in a memory. A processor executes the code to read the information, render a representation of the information handling system from the layout information, and display the representation on a display. The representation includes a connector that is located based on the location information. A method includes displaying a representation of an information handling system and a device. The representation includes depictions of the information handling system and the device. The method also includes receiving an input selecting the depiction of the device, and disabling the device in response to receiving the input. A memory includes code for carrying out the method.

### FIELD OF THE DISCLOSURE

This disclosure relates generally to information handling systems, and relates more particularly to managing devices in an information handling system.

### BACKGROUND

As the value and use of information continues to increase, individuals and businesses seek additional ways to process and store information. One option is an information handling system. An information handling system generally processes, compiles, stores, or communicates information or data for business, personal, or other purposes. Because technology and information handling needs and requirements can vary between different applications, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, data storage systems, and networking systems.

An information handling system can include hardware devices that can be installed, removed, or replaced without having to shut down or reboot the information handling system. Such hardware devices include hot swappable devices such as cooling fans and redundant power supplies in, for example, a tower or blade server system. Hot swapping typically does not involve significant interaction with, or interruption of the operating system. Hot pluggable devices include disk drives, solid-state drives, printers, input/output devices such as keyboards and printers, or other data devices. Hot plugging typically involves interaction with the operating system to ensure that data links between the information handling system and the hot pluggable device are established or severed in an orderly manner. Software can be installed on the information handling system to manage the hot swapping and hot plugging of devices in the information handling system.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are illustrated and described with respect to the drawings presented herein, in which:

FIG. 1 is a block diagram of an information handling system according to an embodiment of the present disclosure;

FIG. 2 is a layout of an information handling system according to an embodiment of the present disclosure;

FIG. 3 is an illustration of a graphical user interface on a display according to an embodiment of the present disclosure; and

FIG. 4 is a flow chart illustrating a method of selectively disabling a device in an information handling system according to an embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features, but can include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and resources described herein. This is done merely for convenience, and to give a general sense of the scope of the invention. This description should be read to include one, or at least one, and the singular also includes the plural, or vice versa, unless it is clear that it is meant otherwise. For example, when a single device is described herein, more than one device can be used in place of a single device. Similarly, where more than one device is described herein, a single device can be substituted for that one device.

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present invention, suitable methods and materials are described below. In case of conflict, the present specification, including definitions, will control. In addition, the materials, methods, and examples are illustrative only, and not intended to be limiting. Note that hereinafter, the terms “hot plug,” “hot plugging,” and “hot pluggable” will be deemed to include the terms “hot swap,” “hot swapping,” and “hot swappable,” respectively, unless otherwise noted.

To the extent not described herein, many details regarding specific materials, processing acts, and circuits are conventional, and can be found in textbooks and other sources within the computing, electronics, and software arts.

A token table that describes the physical layout of an information handling system can be stored in the information handling system. The token table can be accessible to the information handling system's basic input/output system (BIOS), extensible firmware interface (EFI), or another suitable control mechanism or software. The token table can include a layout token that describes the overall outline and configuration of the information handling system. The token table can also include device tokens that define the locations on the outline for attachment and connection of hot pluggable hardware devices.

A graphical user interface (GUI) program can be included in the information handling system that accesses the token to create a graphical representation of the locations of connectors on the information handling system, of the hot pluggable hardware devices coupled to the information handling system, or any combination thereof. The GUI can allow a user to select a particular connector or hot plug device based upon the graphical representation. The GUI can function with the information handling system's BIOS, EFI, or other control mechanism or software to disable the hot plug device. Once the hot plug device is disabled, the GUI can indicate to the user that the device may be safely removed or replaced.

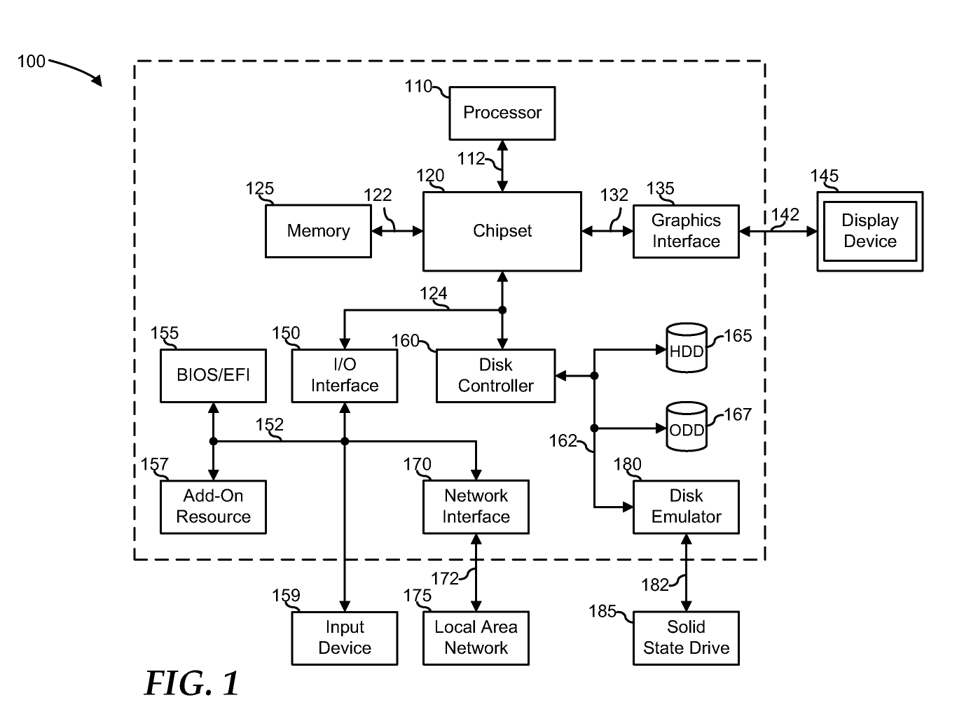

FIG. 1 illustrates a functional block diagram of an embodiment of an information handling system, generally designated as 100. Information handling system 100 includes a processor 110, a chipset 120, a memory 125, a graphics interface 135, an input/output (I/O) interface 150, a BIOS/EFI module 155, an add-on resource 157, a disk controller 160, a hard disk drive (HDD) 165, an optical disk drive (ODD) 167, a network interface 170, and a disk emulator 180. Processor 110 is coupled to chipset 120 via interconnect 112. Chipset 120 supports processor 110, allowing processor 110 to process machine-executable code. In a particular embodiment (not illustrated), information handling system 100 includes one or more additional processors, and chipset 120 supports the multiple processors, allowing simultaneous processing by each of the processors, permitting the exchange of information between the processors and the other elements of information handling system 100. Interconnect 112 can be a unique channel between processor 110 and chipset 120, or can be a bus that shares information between processor 110, chipset 120, and other elements of information handling system 100.

Graphics interface 135 is coupled to chipset 120 via interconnect 132. Interconnect 132 can be a unique channel between chipset 120 and graphics interface 135, or can be a bus that shares information between chipset 120, graphics interface 135, and other elements of information handling system 100. Graphics interface 135 is coupled to a display 145 via a video interconnection 142. In a particular embodiment (not illustrated), graphics interface 135 is coupled to one or more additional displays. A non-limiting example of display 145 includes a liquid crystal display (LCD) panel, a touch-screen panel, another type of display panel, a computer monitor, a television, or a combination thereof. Graphics interface 135 provides visual information to display 145. In a particular embodiment, graphics interface provides visual information to a user of information handling system 100 in the form of a GUI, permitting the user to interact with the information displayed on display 145.

Memory 125 is coupled to chipset 120 via interconnect 122. Interconnect 122 can be a unique channel between chipset 120 and memory 125, or can be a bus that shares information between chipset 120, memory 125, and other elements of information handling system 100. For example, a bus can share information between processor 110, chipset 120 and memory 125. In a particular embodiment (not illustrated), processor 110 is coupled to memory 125 through a unique channel. In accordance with another aspect (not illustrated), an information handling system can include a separate memory dedicated to each of the processors. A non-limiting example of memory 125 includes static, dynamic. Or non-volatile random access memory (SRAM, DRAM, or NVRAM), read only memory (ROM), flash memory, another type of memory, or any combination thereof.

I/O interface 150 is coupled to chipset 120 via interconnect 124. Interconnect 124 can be a unique channel between chipset 120 and I/O interface 150, or can be a bus that shares information between chipset 120, I/O interface 150, and other elements of information handling system 100. Other I/O interfaces (not illustrated) can also be used in addition to I/O interface 150 if needed or desired. I/O interface 150 is coupled to BIOS/EFI module 155 via interconnect 152. BIOS/EFI module 155 can include BIOS/EFI code that is operable to detect and identify resources within information handling system 100, provide the appropriate drivers for those resources, initialize those resources, and access those resources. In a particular embodiment, BIOS/EFI module includes System Management BIOS (SMBIOS) that includes data structures that relate to the particular features of information handling system 100.

Interconnect 152 can include a bus structure that allows the installation and coupling of add-on resource 157 to information handling system 100. In accordance with an aspect (not illustrated), interconnect 152 can include one or more point-to-point links to add-on resource 157. Add-on resource 157 can include a data storage system, a graphics interface, a network interface card (NIC), a sound/video processing card, another suitable add-on resource or any combination thereof. Add-on resource 157 can be on a main circuit board, on a separate circuit board or add-in card disposed within information handling system 100, a device that is external to information handling system 100, or any combination thereof. As such, interconnect 152 can include a connector to facilitate attachment of add-on resource 157.

I/O interface 150 is coupled to an input device 159 via interconnect 152. Input device 159 permits a user of information handling system 100 to manipulate information handling system 100. A non-limiting example of an input device is a mouse, a keyboard, a pen pad, another input device, or a combination thereof. In general, information handling system 100 can execute machine-executable code which permits the user to see information on a display 145, as described below, and to manipulate the information through use of input device 159. In a particular embodiment, interconnect 152 is configured to enable hot plugging of add-on resource 157 and input device 159.

Network interface device 170 is coupled to I/O interface 150 via interconnect 152. Interconnect 152 can be a unique channel between I/O interface 150 and network interface device 170, or can be a bus that shares information between I/O interface 150, network interface device 170, and other elements of information handling system 100. Other network interfaces (not illustrated) can also be used in addition to network interface device 170 if needed or desired. Network interface device 170 can be a network interface card (NIC) disposed within information handling system 100, on a main circuit board (e.g., a baseboard, a motherboard, or any combination thereof), integrated onto another component such as chipset 120, in another suitable location, or any combination thereof. Network interface device 170 includes a network channel 172 that provides an interface between information handling system 100 and a local area network 175. Network interface device 170 can also include additional network channels (not illustrated).

Disk controller 160 is coupled to chipset 120 via interconnect 124. In another embodiment, disk controller 160 can be coupled to chipset 120 via a unique channel (not illustrated). Other disk controllers (not illustrated) can also be used in addition to disk controller 160 if needed or desired. Disk controller 160 can include a disk interface 162. Disk controller 160 can be coupled to one or more disk drives via disk interface 162. Such disk drives include HDD 165 and ODD 167 (e.g., a Read/Write Compact Disk (R/W-CD), a Read/Write Digital Video Disk (R/W-DVD), a Read/Write mini Digital Video Disk (R/W mini-DVD), or another type of optical disk drive), or any combination thereof. In a particular embodiment, disk interface 162 is configured to enable hot plugging of HDD 165 and ODD 167. Additionally, disk controller 160 can be coupled to disk emulator 180 via interconnect 162. Disk emulator 180 can permit a solid-state drive 185 to be coupled to information handling system 100 via an external interface 182. External interface 182 can include industry standard busses (e.g., USB or IEEE 1384 (Firewire)) or proprietary busses, or any combination thereof. Alternatively, solid-state drive 185 can be disposed within information handling system 100. In a particular embodiment, external interface 182 is configured to enable hot plugging of solid-state drive 185.

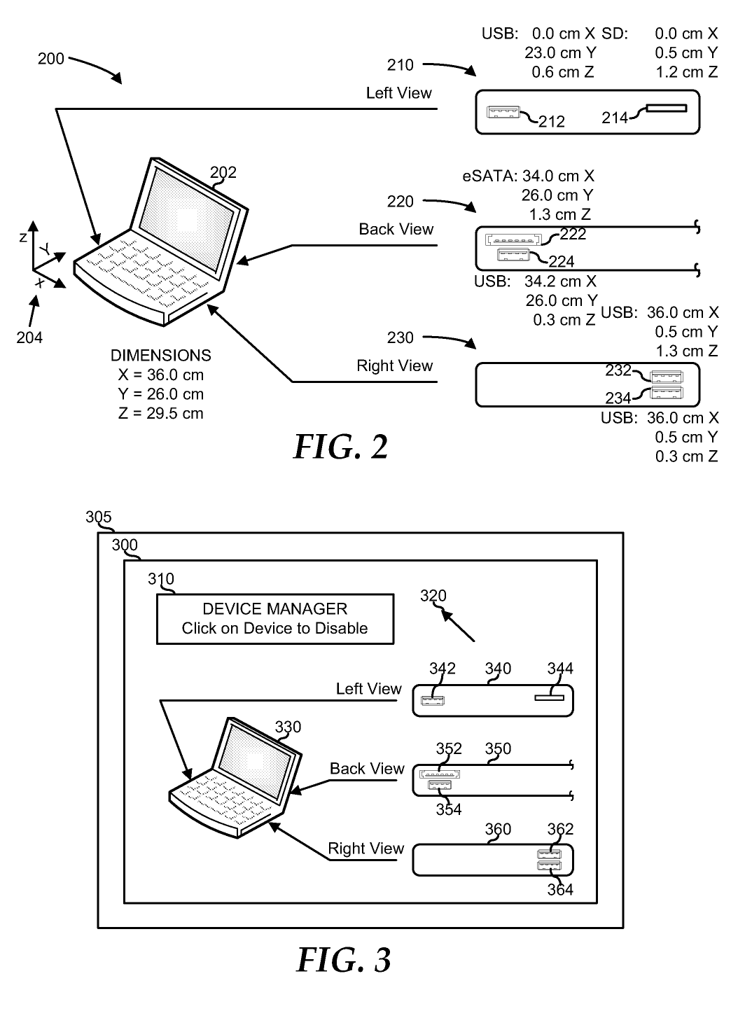

FIG. 2 illustrates a layout of an information handling system 202 according to an embodiment of the present disclosure. Information handling system 202 is illustrated in a perspective view 200, a left side view 210, a back side view 220, and a right side view 230. Perspective view 200 illustrates information handling system 202 with a coordinate grid 204 to create a reference for the size and shape of information handling system 202. As indicated, information handling system 202 is 36.0 centimeters (cm) in the “X” axis, 26.0 cm in the “Y” axis, and 29.5 cm in the “Z” axis. While all dimensions and location coordinates herein are described in centimeters, it will be understood after reading this disclosure that other standards of measure can be chosen. A non-limiting example of a standard of measure includes the English standard units of inches, another recognized standard of measure or fraction thereof, or a standard of measure that is proprietary may be chosen. Also, while information handling system 202 is illustrated as a laptop computer system, the skilled artisan will understand after reading this disclosure that other information handling system configurations can be measured in a similar way. A non-limiting example of an information handling system includes a personal computer system, a tower server, a blade server, a personal data assistant, or another information handling system. As illustrated, the “X”, “Y”, and “Z” axes of coordinate grid 204 are substantially orthogonal to each other. In another embodiment, a coordinate grid can be used that includes axes that are not substantially orthogonal to each other, or that does not include axes, as, for example, a cylindrical coordinate system or a spherical coordinate system.

Left side view 210 includes a Universal Serial Bus (USB) connector 212 and a Secure Digital card (SD) connector 214. As indicated, USB connector 212 is located at X=0.0 cm, Y=23.0 cm, and Z=0.6 cm, and SC connector 214 is located at X=0.0 cm, Y=0.5 cm, and Z=0.3 cm. Back side view 220 includes a Serial Advanced Technology Attachment (eSATA) connector 222, and a USB connector 224. As indicated, eSATA connector 222 is located at X=34.0 cm, Y=26.0 cm, and Z=1.3 cm, and USB connector 224 is located at X=34.2 cm, Y=26.0 cm, and Z=0.3 cm. Right side view 230 includes a USB connector 232, and a USB connector 234. As indicated, USB connector 232 is located at X=36.0 cm, Y=0.5 cm, and Z=1.3 cm, and USB connector 234 is located at X=36.0 cm, Y=0.5 cm, and Z=0.3 cm. USB connectors 212, 224, 232, and 234, SD connector 214, and eSATA connector 222 all support hot pluggable add-on resources similar to add-on resource 157, input devices similar to input device 159, disk drives similar to HDD 165 and ODD 167, solid-state drives similar to solid-state drive 185, and other hot pluggable devices. In a particular embodiment, the case of information handling system 202 can include markings on the case to identify a coordinate axis similar to coordinate axis 204, or to provide hash marks in accordance with a selected standard of measure to assist a user in locating the connectors.

TABLE 1
Token Table

| | Token |
|---|---|
| Token Type | (Configuration Code/X/Y/Z) |
| Layout | 0/36.0/26.0/29.5 |
| Device | 6/00.0/23.0/00.6 |
| Device | 8/00.0/23.0/00.6 |
| Device | 7/00.0/00.5/01.2 |
| Device | 6/34.2/26.0/00.3 |
| Device | 6/36.0/00.5/00.3 |
| Device | 6/36.0/00.5/01.3 |

Table 1 is an illustration of a token table according to an embodiment of the present disclosure. The token table includes information that describes the physical layout of information handling system 202. The information is in the form of a single layout token that describes the layout of information handling system 202, and multiple device tokens that each describe the location of the associated hot pluggable connectors 212, 214, 222, 224, 232, and 234. The token table has a token type column and a token column. A particular token can either be a layout token, such as the token in the first row, or a device token, such as the tokens in the second through the seventh rows. As illustrated, a particular token includes a configuration code. The configuration code is a numbered code that describes the configuration of information handling system 202 for the layout token, and describes the type of hot pluggable connector for the device tokens.

TABLE 2
Configuration Code

| Configuration | Token | Configuration or |
|---|---|---|
| Code | Type | Device Type |
| 0 | Layout | Laptop Computer |
| 1 | Layout | Desktop Computer |
| 2 | Layout | Tower Server |
| 3 | Layout | Blade Server |
| 4 | Layout | Rack Server |
| 5 | Layout | Personal Data Assistant |
| 6 | Device | USB connector |
| 7 | Device | eSATA connector |
| 8 | Device | SD connector |
| 9 | Device | Cooling Fan |
| 10 | Device | Power Supply |

Table 2 illustrates an embodiment of the encoding of the configuration code. Each particular token also includes “X,” “Y.,” and “Z” coordinates. The coordinates describe the dimensions of information handling system 202 for the layout token, and the location of the associated connector for the device tokens. Thus, the layout token is understood to describe a laptop computer (configuration code “0”) that is 36.0 cm×26.0 cm×29.5 cm. The first device token (e.g., the second row of table 1) describes a USB connector located at X=00.0 cm, Y=23.0 cm, and Z=29.5 cm. The second through the sixth device tokens are each understood similarly, and will not be further described herein. After reading this disclosure, the skilled artisan will understand that other encodings can be used. Also, additional layouts and additional device types can be encoded. The coordinates can represent dimensions in centimeters, inches, or another standard of measure. Further, while the coordinates are represented in token 300 in decimal form, the skilled artisan will understand that the coordinates can be represented in binary coded decimal form, in binary form, including octal, hexadecimal or another digital form, or in another form.

The token table is stored in a suitable location in information handling system 202. In a non-limiting example, the token table can be stored in a memory similar to memory 125, in a hard disk drive similar to HDD 165, in an optical disk drive similar to ODD 167, in another similar data storage location, or a combination thereof. The token table is accessible to a system BIOS, EFI, SMBIOS or another suitable control mechanism or software.

FIG. 3 illustrates a graphical user interface (GUI) 300 on a display 305 similar to display 145. GUI 300 includes an instruction field 310, a pointer 320, a perspective graphical representation (GR) 330 of an information handling system, a left side GR 340, a back side GR 350, and a right side GR 360. GUI 300 accesses a token table (not illustrated) similar to the token table in Table 1 to determine a configuration and size of the information handling system, and the type and location of the connectors or devices on the information handling system. In particular, GUI 300 accesses a layout token similar to the layout token in Table 1 to determine the configuration of the information handling system based on the configuration code, and to determine the dimensions of the information handling system based upon the coordinates. From this information, GUI 300 renders perspective GR 330. GUI 300 accesses one or more device tokens similar to the device tokens in Table 1 to determine the configuration of each particular connector or device in the information handling system based on the configuration code, and to determine the location of each particular connector or device based upon the coordinates. From this information, GUI 300 renders left side GR 340 with a representation 342 of a USB connector and a representation 344 of an SD connector, renders back side GR 350 with a representation 352 of an eSATA connector and a representation 354 of a USB connector, and renders right side GR 360 with representations 362 and 364 of USB connectors.

A user of the information handling system can manipulate an input device similar to input device 159 to move pointer 320 around GUI 300. In this way, the user can move pointer 320 into the proximity of a particular connector representation 342, 344, 352, 354, 362, or 364 and select the representation. GUI 300 then accesses the information handling system's BIOS, EFI, or other control mechanism or software to disable the device associated with the particular representation. Once the represented device is disabled, GUI 300 can indicate to the user that the selected device may be safely removed or replaced. A non-limiting example of an indication includes changing the color of the particular representation, depicting an “X” through the representation, another suitable form of indication, or a combination thereof.

In a particular embodiment (not illustrated), a GUI can determine the type of device that is coupled to a connector (e.g., a printer, a solid-state memory device, etc.) and can depict the associated graphical representation with a representation of the device on or near to the representation of the connector. In another embodiment (not illustrated), a GUI can determine a name of a device that is coupled to a connector and can depict the associated graphical representation with the name of the device on or near to the representation of the connector. Also, a GUI can depict a device that is coupled to a connector, but is remote from the information handling system (e.g., printer, mouse, keyboard, etc.). In this case, a user selects either the depiction of the device, or the connector, and the coupled device is disabled.

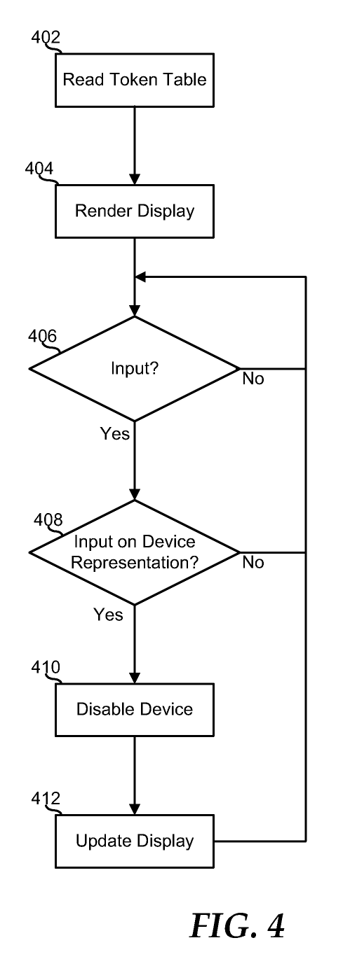

FIG. 4 is a flow chart illustrating a method of selectively disabling a device in an information handling system according to an embodiment of the present disclosure. A token table is read from a memory in an information handling system in block 402. For example, a graphical user interface similar to GUI 300 can read a token table similar to the token table in Table 1. Based upon the information in the token table, a display is rendered which depicts the information handling system and the location of associated hot pluggable connectors in block 404. For example, GUI 300 can create perspective GR 330, left side GR 340, back side GR 350, and right side GR 360, and display the rendered image on display 305. A decision is made in decision block 406 as to whether or not a user input is received. For example, a user can manipulate pointer 320 on GUI 300. If a user input has not been received, then the “NO” branch of decision block 406 is taken, and processing loops back to decision block 406 until a user input is received. If a user input has been received, the “YES” branch of decision block 406 is taken and a decision is made in decision block 408 as to whether or not the input included selecting a representation of a connector or device. For example, a user can manipulate pointer 320 to select representation 342 of the USB connector on the left side of the information handling system. If the input did not include selecting a representation of a connector or device, then the “NO” branch of decision block 408 is taken, and processing loops back to decision block 406 until another user input is received. If the input included selecting a representation of a connector or device, then the “YES” branch of decision block 408 is taken, and the corresponding device is disabled in block 410. For example, the USB device associated with representation 342 can be disabled by GUI 300. The rendered display is updated to show that the selected device was disabled in block 412, and processing loops back to decision block 406 until another user input is received.

For purposes of this disclosure, an information handling system can include any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system can be a personal computer, a personal data assistant, a consumer electronic device (e.g., a portable music player, a portable DVD player, or a digital video recorder, etc.), a network communication device (e.g., a server or server blade, a storage device, a switch/router, a wireless router, etc.), or any other suitable device, and can vary in size, shape, performance, functionality, and price. An information handling system can also include a set of any of the foregoing devices.

Portions of an information handling system, when referred to as a “device,” a “module,” a “resource,” or the like, can be configured as hardware, firmware, software, or any combination thereof. A device, a module, or a resource can be implemented in hardware. A non-limiting example of a device, a module, or a resource implemented as hardware includes: an integrated circuit (e.g., an Application Specific Integrated Circuit (ASIC), a Field Programmable Gate Array (FPGA), a structured ASIC, or a device embedded on a larger chip), a card (e.g., a Peripheral Component Interface (PCI) card, a PCI-Express (PCIe) card, a Personal Computer Memory Card International Association (PCMCIA) card, or other such expansion card), or a system (e.g., a motherboard, a system-on-a-chip (SoC), or a stand-alone device). Similarly, the device, a module, or a resource can be implemented in firmware (i.e., any software running on an embedded device, a Pentium class or PowerPC™ brand processor, or other such device) or in software (i.e., any software capable of operating in the relevant environment). The device, module, or resource can also be implemented as a combination of hardware, firmware, or software. Note that an information handling system can include an integrated circuit or a board-level product having portions thereof that can also be any combination of hardware, firmware, or software.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

The embodiments discussed above describe, in part, distributed computing solutions that manage all or part of a communicative interaction between network elements. A network element can be a node, a piece of hardware, software, firmware, middleware, another component of a computing system, or any combination thereof. In this context, a communicative interaction can be intending to send information, sending information, requesting information, receiving information, receiving a request for information, or any combination thereof. As such, a communicative interaction could be unidirectional, bi-directional, multi-directional, or any combination thereof. In some circumstances, a communicative interaction could be relatively complex and, involve two or more network elements. For example, a communicative interaction can be “a conversation,” or series of related communications between a client and a server—each network element sending and receiving information to and from the other. Whatever form the communicative interaction takes, the network elements involved need not take any specific form.

Two or more information handling systems can be coupled together in a network such that individual information handling systems in the network, referred to as nodes of the network, can exchange information with each other. A non-limiting example of a network includes a local area network (LAN), a metropolitan area network (MAN), a storage area network (SAN), a wide area network (WAN), a wireless local area network (WLAN), a virtual private network (VPN), an intranet, the Internet, any other appropriate network architecture or system, or any combination thereof. The nodes on a network can include storage devices, file servers, print servers, personal computers, laptop computers, personal data assistants, media content players, other devices capable of being coupled to a network, or any combination thereof.

In the description above, a flow-charted technique can be described in a series of sequential actions. The sequence of the actions and the party performing the steps can be freely changed without departing from the scope of the teachings. Actions can be added, deleted, or altered in several ways. Similarly, the actions can be re-ordered or iterated. Further, although processes, methods, algorithms, or the like can be described in a sequential order, such processes, methods, algorithms, or any combination thereof can be operable to be performed in alternative orders. Further, some actions within a process, method, or algorithm can be performed simultaneously during at least a point in time (e.g., actions performed in parallel), can also be performed in whole, in part, or any combination thereof.

In a first aspect, an information handling system includes a memory, a display and a processor. The memory stores machine-executable code, layout information for the information handling system, and location information for a connector of the information handling system. The processor is operable to execute the machine-executable code to read the layout information and the location information from the memory, render a graphical representation of the information handling system that corresponds to the physical appearance of the information handling system based on the layout information, and display the graphical representation on the display. The graphical representation includes a connector representation that corresponds to the physical appearance of the connector, and the location of the connector representation on the graphical representation is based on the location information.

In an embodiment of the first aspect, the information handling system includes an input device coupled to the processor, and the processor is also operable to receive an input from the input device selecting the connector representation. In another embodiment, the processor is operable to disable a device that is coupled to the connector in response to receiving the input. In yet another embodiment, the device is a hot pluggable device. In still another embodiment, the location of the connector representation on the graphical representation corresponds to a physical location of the connector on the information handling system. In a further embodiment, the connector representation depicts a universal serial bus connector. In another embodiment, the layout information and the location information is stored in a system management BIOS memory. In still another embodiment, the machine-executable code is stored in an EFI memory.

In a second aspect, a method includes displaying a graphical representation of an information handling system and a device coupled to the information handling system. The graphical representation includes a first depiction that corresponds to a first physical appearance of the information handling system and a second depiction that corresponds to a second physical appearance of the device coupled to the information handling system. The method also includes receiving an input corresponding to a selection of the second depiction, and disabling the device in response to receiving the input.

In an embodiment of the second aspect, the method includes reading a token from a memory of the information handling system, and the graphical representation is displayed in response to reading the token. In another embodiment, the token includes layout information for the information handling system, and location information corresponding to a location on the information handling system where the device is coupled to the information handling system. In still another embodiment, the first depiction is based upon the layout information, and the second depiction is based upon the location information. In yet another embodiment the second depiction includes a connector type associated with the device. In a further embodiment, disabling the device includes removing a hot pluggable device.

In a third aspect, a memory for an information handling system stores machine-executable code. The machine-executable code includes instructions for carrying out a method including displaying a graphical representation of an information handling system and a device coupled to the information handling system. The graphical representation includes a first depiction that corresponds to a first physical appearance of the information handling system and a second depiction that corresponds to a second physical appearance of the device coupled to the information handling system. The method also includes receiving an input corresponding to a selection of the second depiction, and disabling the device in response to receiving the input

In an embodiment of the third aspect, the method includes reading a token from a memory of the information handling system, and the graphical representation is displayed in response to reading the token. In another embodiment, the token includes layout information for the information handling system, and location information corresponding to a location on the information handling system where the device is coupled to the information handling system. In still another embodiment, the first depiction is based upon the layout information, and the second depiction is based upon the location information. In yet another embodiment the second depiction includes a connector type associated with the device. In a further embodiment, disabling the device includes removing a hot pluggable device.

Note that not all of the activities described above in the general description or the examples are required, that a portion of a specific activity can not be required, and that one or more further activities can be performed, in addition to those described. Still further, the order in which activities are listed are not necessarily the order in which they are performed.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Many other embodiments can be apparent to those of skill in the art upon reviewing the disclosure. Other embodiments can be used and derived from the disclosure, such that a structural substitution, logical substitution, or another change can be made without departing from the scope of the disclosure. Accordingly, the disclosure is to be regarded as illustrative rather than restrictive.

Certain features described herein in the context of separate embodiments for the sake of clarity, can also be provided in combination in a single embodiment. Conversely, various features that are, for brevity, described in the context of a single embodiment, can also be provided separately, or in any sub-combination. Further, reference to values stated in ranges includes each and every value within that range.

Benefits, other advantages, and solutions to problems have been described above with regard to specific embodiments. However, the benefits, advantages, solutions to problems, and any feature(s) that can cause any benefit, advantage, or solution to occur, or become more pronounced are not to be construed as a critical, required, or essential feature of any or all the claims.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system comprising:
a memory having:
machine-executable code stored therein;
layout information for the information handling system stored therein; and
location information for a connector of the information handling system stored therein;
a display; and
a processor operable to execute the machine-executable code to:
read the layout information and the location information from the memory;
render a graphical representation of the information handling system that corresponds to a first physical appearance of the information handling system based on the layout information, wherein the graphical representation includes a connector representation that corresponds to a second physical appearance of the connector, and wherein the location of the connector representation on the graphical representation is based on the location information; and
display the graphical representation on the display.

2. The information handling system of claim 1, further comprising:
an input device operably coupled to the processor; and
wherein the processor is further operable to receive an input from the input device selecting the connector representation.

3. The information handling system of claim 2, wherein, in response to receiving the input, the processor is further operable to disable a device of the information handling system that is coupled to the connector.

4. The information handling system of claim 3, wherein the device is a hot pluggable device.

5. The information handling system of claim 1, wherein the location of the connector representation on the graphical representation corresponds to a physical location of the connector on the information handling system.

6. The information handling system of claim 1, wherein the connector representation depicts a universal serial bus connector.

7. The information handling system of claim 1, wherein the layout information and the location information is stored in a system management basic input/output system memory.

8. The information handling system of claim 1, wherein the machine-executable code is stored in an extensible firmware architecture memory.

9. A method comprising:
displaying a graphical representation of an information handling system that includes a device coupled thereto, wherein the graphical representation includes:
a first depiction that corresponds to a first physical appearance of the information handling system; and
a second depiction that corresponds to a second physical appearance of the device coupled to the information handling system;
receiving an input corresponding to a selection of the second depiction; and
in response to receiving the input, disabling the device.

10. The method of claim 9, further comprising:
reading a token from a memory of the information handling system; and
wherein displaying the graphical representation is in response to reading the token.

11. The method of claim 10, wherein the token includes:
layout information for the information handling system; and
location information corresponding to a location on the information handling system where the device is coupled to the information handling system.

12. The method of claim 11, wherein:
the first depiction is based upon the layout information; and
the second depiction is based upon the location information.

13. The method of claim 12, wherein the second depiction includes a connector type associated with the device.

14. The method of claim 9, wherein disabling the device includes removing a hot pluggable device.

15. A memory for an information handling system, wherein the memory has machine-executable code stored therein, and wherein the machine-executable code includes instructions for carrying out a method comprising:
displaying a graphical representation of an information handling system that includes a device coupled thereto, wherein the graphical representation includes:
a first depiction that corresponds to a first physical appearance of the information handling system; and
a second depiction that corresponds to a second physical appearance of the device coupled to the information handling system;
receiving an input corresponding to a selection of the second depiction; and
in response to receiving the input, disabling the device.

16. The memory of claim 15, wherein the method further comprises:
reading a token from a memory of the information handling system; and
wherein displaying the graphical representation is in response to reading the token.

17. The memory of claim 16, wherein the token includes:
layout information for the information handling system; and
location information for the device.

18. The memory of claim 17, wherein:
the first depiction is based upon the layout information; and
the second depiction is based upon the location information.

19. The memory of claim 18, wherein the second depiction includes a connector type associated with the device.

20. The memory of claim 15, wherein disabling the device includes removing a hot pluggable device.
